(19) United States
(12) Patent Application Publication
(10) Pub. No.: US 2014/0353522 A1
(43) Pub. Date: Dec. 4, 2014

(54) Apparatus and methodology for flow fluorescence microscopic imaging

(71) Applicant: Hong Kong Baptist University, Hong Kong (HK)

(72) Inventors: Jianglai WU, Hong Kong (HK); Jianping LI, Hong Kong (HK); Kai Yiu Robert CHAN, Hong Kong (HK)

(73) Assignee: Hong Kong Baptist University, Hong Kong (HK)

(21) Appl. No.: 14/289,642

(22) Filed: May 28, 2014

(30) Foreign Application Priority Data
May 28, 2013 (CN) 201310202769.7

(51) Int. Cl. G01N 21/64

(52) U.S. Cl. CPC G01N 21/6458
USPC 250/458.1

(57) ABSTRACT

The present invention is to provide a flow fluorescence microscopic imaging apparatus. More particularly, it relates to a fluorescence microscopic imaging apparatus which combines the fluorescence microscopy excited by light sheet and flow cytometry. The present invention provides a new methodology in the field of flow cytometry based on the flow fluorescence microscopic imaging device, which is able to solve the problem of small depth-of-field (DOF) and the motion blur when the flow objects are imaged.

### CROSS-REFERENCE TO RELATED APPLICATIONS

The present application claims priority of the People's Republic of China patent application number 201310202769.7 filed on May 28, 2013, and which the disclosure is hereby incorporated by reference in their entirety.

### FIELD OF INVENTION

This invention relates to an apparatus and methodology for flow fluorescence microscopic imaging, more specifically, to an imaging flow cytometer which combines merits of both light sheet fluorescence microscopy and flow cytometry. The invention has a wide scope of applications in providing a new imaging flow cytometer, with the ability to suppress the out-of-focus light and motion blur that limit the performance of existing technologies.

### BACKGROUND OF INVENTION

Conventional optical microscopy and flow cytometry are important tools in industrial, scientific, and biomedical applications. The technology incorporating imaging in a flow cytometer has the advantages of high spatial resolution from optical microscopy and high throughput from flow cytometry. However, the performance of existing instruments is circumscribed by two intrinsic limitations in imaging flow cytometry.

The first limitation is out-of-focus light fogging up the image because of the small depth-of-field (DOF) of a microscope, especially when high magnification objective lenses (e.g. high numerical aperture (NA)) are used. The larger the NA corresponds to a smaller focal depth. For example, a 20× objective with the NA of 0.4, the DOF is only about 6 μm. To minimize out-of-focus blurring, the particles need to be confined within the DOF. This is frequently addressed by:

1) Using a low magnification objective lens to get a large DOF by compromising the resolution. Such strategy also decreases the throughput as small flow channels are required.
2) Using an auxiliary optical device in the optical path to extend the DOF. This method greatly increases the complexity of the system with a decrease in resolution and sensitivity due to the introduction of the extra optical component.

The second limitation is the motion blur caused by the relative motion between the cells to the camera. It is common knowledge that the faster the moving object, the more acute is the problem of blurring of the image. To suppress motion blur, one method is to use a light-flash or to use a fast capturing camera to freeze the motion in the image. However, such approach drastically decreases the sensitivity of the system because the availability of photons captured in the short exposure time is reduced. Another method is to use a special camera, such as the time delay integration (TDI) camera, to synchronize the motion. However, such an approach presents challenges to the flow control system as any changes in the motions caused by cells rotation, translation, and velocity gradients among cells, will lead to motion blurs.

To address the two aforementioned limitations in the conventional imaging flow cytometry, in the present invention, a light sheet based apparatus and methodology for flow fluorescence microscopic imaging is provided. By the present invention, the out-of-focus light arising from the small DOF in conventional microscopic imaging is greatly suppressed by using a light sheet illumination, and the existing problem of motion blur is also suppressed by taking images from the particles' moving direction in the present invention, which is different from existing technologies.

Citation or identification of any reference in this section or any other section of this application shall not be construed as an admission that such reference is available as prior art for the present application.

### SUMMARY OF INVENTION

The present invention provides an apparatus and methodology for flow fluorescence microscopic imaging that can address the two obscuring sources, viz. out-of-focus blur and motion blur, which restrict the performance of existing technologies. The out-of-focus light is addressed by using light sheet illumination, and the motion blur is suppressed by imaging from the particles' flow direction. Free from the two blur sources, the instrument of the present invention can achieve a high throughput without compromising spatial resolution.

In a first aspect of the present invention, there is provided a flow fluorescence microscopic imaging apparatus comprising a laser light sheet generation unit, a liquid sample delivery unit, and a fluorescence microscopic imaging unit, wherein the direction of flow of the liquid sample and the optical axis of the fluorescence microscopic imaging unit are parallel to each other, and are perpendicular to the optical axis of the light sheet generation unit.

In a first embodiment of the first aspect of the present invention, there is provided a flow fluorescence microscopic imaging apparatus characterized in that the thickness of the light sheet formed by the laser light source is close to the DOF of the fluorescence microscopic imaging unit.

In a second embodiment of the first aspect of the present invention, there is provided a flow fluorescence microscopic imaging apparatus, wherein said light sheet is formed by a laser light source, a collimator lens, a cylindrical lens, and a microscope objective lens.

In a third embodiment of the first aspect of the present invention, there is provided a flow fluorescence microscopic imaging apparatus characterized in that the liquid sample delivery unit comprises injection pumps, hoses, a flow chamber, and the sample; the sample follows a sheath flow to flow at the core portion of the main flow tube, the cross-section of the flow tube may be square or circular, preferably a square tube.

In a fourth embodiment of the first aspect of the present invention, there is provided a flow fluorescence microscopic imaging apparatus characterized in that the fluorescence microscopic imaging unit comprises a liquid flowing out of the sample delivery unit, said liquid filling up the space between the objective lens and the light sheet illumination plane; the objective lens is an infinity-corrected water dipping objective lens.

In a second aspect of the present invention, there is provided a flow fluorescence microscopic imaging method, wherein light sheet illumination is formed in the center of the sample delivery unit from the light sheet generation unit; liquid samples flowing through the light sheet stimulates fluorescence emission from fluorescent particles and thereby forms images at the back focal plane of the fluorescence microscopic imaging unit; the direction of flow of the liquid sample and the optical axis of the fluorescence imaging unit are parallel to each other, and are perpendicular to the optical axis of the light sheet generation unit.

In a first embodiment of the second aspect of the present invention, there is provided a flow fluorescence microscopic imaging apparatus characterized in that the thickness of the light sheet formed by the laser light source is close to the DOF of the fluorescence microscopic imaging unit.

In a second embodiment of the second aspect of the present invention, there is provided a flow fluorescence microscopic imaging apparatus wherein said light sheet is formed by a laser light source, a collimator lens, a cylindrical lens, and a microscope objective lens.

In a third embodiment of the second aspect of the present invention, there is provided a flow fluorescence microscopic imaging apparatus characterized in that the liquid sample delivery unit comprises injection pumps, hoses, a flow chamber, and the sample; the sample follows the sheath flow to flow at the core portion of the main flow tube; the cross-section of the flow tube may be square or circular, preferably a square tube.

In a fourth embodiment of the second aspect of the present invention, there is provided a flow fluorescence microscopic imaging apparatus characterized in that the fluorescence microscopic imaging unit comprises the liquid flowing out of the sample delivery unit, said liquid filling up the space between the objective lens and the and the light sheet illumination plane; the objective lens is an infinity-corrected water dipping objective lens.

### BRIEF DESCRIPTION OF DRAWINGS

The above and other objects and features of the present invention will become apparent from the following description of the present invention, when taken in conjunction with the accompanying diagrams, in which:

FIG. 1 shows the schematic diagram of flow fluorescence microscopic imaging apparatus.

FIG. 2 shows the schematic diagram of the light sheet excitation unit.

FIG. 3 shows the side view of the light sheet generation unit.

FIG. 4 shows the top view of the light sheet generation unit.

FIG. 5 shows the schematic diagram of the liquid sample delivery unit.

FIG. 6 shows the schematic diagram of the fluorescence microscopic imaging unit.

FIG. 7 shows (a) Laser scattering image of the sample core, 580×580 pixels, scale bar: 20 μm, exposure time: 500 ms; (b) Timing chart of the trigger and camera synchronization control.

FIG. 8 shows the characteristics of the light sheet generated: (a) Image of the light sheet, taken with a 5×(NA=0.2) objective lens from the side with the flowing of chlorophyll solution; (b) Intensity profile of the light sheet, Full Width at Half Maximum (FWHM) is 5.39±0.13 μm.

FIG. 9 shows the experimentally measured Point Spread Functions (PSFs): (a) Lateral PSF measured by fluorescence imaging: the FWHM is 0.81±0.07 μm; (b) Axial PSF measured by laser scattering imaging: the FWHM is 1.42±0.15 μm.

FIG. 10 shows the images of Gambierdiscus sp. and Procentrum sp. captured with the 3D imaging flow cytometer: (a) Maximum projection of the stack of 30 images of Procentrum sp.; (b) A single image out of the 30 planes; (c) and (d) are maximum projection of two different Gambierdiscus sp. cells, respectively, where (c) has a stack of 35 images and (d) has a stack of 38 images; (e) Projections of the same stack used in (d) along lateral direction. Scale bars are 10 μm.

FIG. 11 shows the schematic diagram of the 2D fluorescence imaging flow cytometer: (a) side view; (b) top view.

FIG. 12 shows the experimentally measured lateral PSF; (a) Integrated-intensity projection of the 3D PSF of the imaging optics, 51×51 pixels; (b) Intensity profile of the PSF, FWHM is 0.75±0.06 μm.

FIG. 13 shows the images obtained from natural coastal water samples: (a) Single frame; (b) Maximum projection of 60 deconvolved images. Experimental conditions: volume rate is 1 ml/min; exposure time is 1 s. Scale bars: 20 μm.

FIG. 14 shows the comparison between original and deconvolved image: (a) Original image; (b) Deconvolved image. White curves are the intensity profiles along the grey lines selected. Scale bars: 10 μm.

FIG. 15 shows the imagery of phytoplankton with different morphologies obtained from natural coastal water samples.

### DETAILED DESCRIPTION OF THE INVENTION

The claimed invention is further illustrated by the following examples or embodiments which should be understood that the subject matters disclosed in the examples or embodiments may only be used for illustrative purposes but are not intended to limit the scope of the presently claimed invention.

This invention provides a new methodology of flow fluorescence microscopic imaging apparatus, which is able to solve the problem of small DOF and the motion blur caused when flowing objects are imaged. The out-of-focus background is reduced by using thin light sheet illumination which also increases the sensitivity of the system. The problem of motion blur can be restrained effectively by having the optical axis of the microscopic imaging unit placed in the direction of the flow that is parallel to the cells' motion. This method of imaging is able to detect multiple cells at the same time which can greatly increase the speed of image capture for high throughout applications.

The presently claimed flow fluorescence microscopic imaging apparatus includes a light sheet generation unit, a liquid sample delivery unit and a fluorescence microscopic imaging unit. The role of the light sheet generation unit is to generate a light sheet from a continuous wave (CW) laser source perpendicular to the flow direction of liquid sample. The optical axis of the fluorescence microscopic imaging unit is positioned parallel to the flow of the liquid sample.

The light sheet generation unit of the present invention is configured to produce a thin sheet of light where the thickness of the light sheet is of dimensions close to the DOF of the microscopic imaging unit projected into the flow tube.

The presently claimed light sheet generation unit includes single mode fiber (SMF) laser, a collimating lens, a cylindrical lens, and a microscope objective lens.

The presently claimed liquid sample delivery unit includes an injection pump to inject liquid into the flow tube, and a sample introduction capillary where the cross-section of the flow capillary can be square or circular, and the square tube can more easily achieve uniform light sheet inside the tube.

The presently claimed fluorescence microscopic imaging unit includes a microscope objective lens and the liquid (usually water) from the sample delivery unit filling up the space between the objective lens and the light sheet illumination plane; the objective lens is an infinity-corrected water dipping objective lens.

The presently claimed light sheet from the light sheet generation unit illuminates onto the central part of the sample delivery unit, and the liquid sample traversing through the light sheet stimulates fluorescence emission from the particles.

Implementation

The following description is for further illustration of the present invention by combining the figures and the examples.

As a flow fluorescence microscopic imaging apparatus, the present invention is able to solve the problems of the small DOF in conventional microscopic imaging and the motion blur caused when taking images of the moving objects. The advantages of the present invention includes: 1) the problem of the small DOF of the conventional fluorescence microscopic imaging techniques can be solved by the presently claimed light sheet generation unit of which the thickness is close to the DOF of the microscopic imaging unit. The light sheet of the present invention is used to stimulate the autofluorescence or the non-autofluorescence of the particles; 2) the sensitivity of the presently claimed system is enhanced because the fluorescence can only be emitted by the stimulated particles illuminated within the light sheet which reduces the background light contamination on the fluorescence image; 3) the phenomenon of motion blur is effectively suppressed because the fluorescence light emitted from the particles contained in the sample traversing through the light beam are collected at particles' moving direction; 4) the throughput of particle detection is increased by the device which can detect multiple cells at the same time.

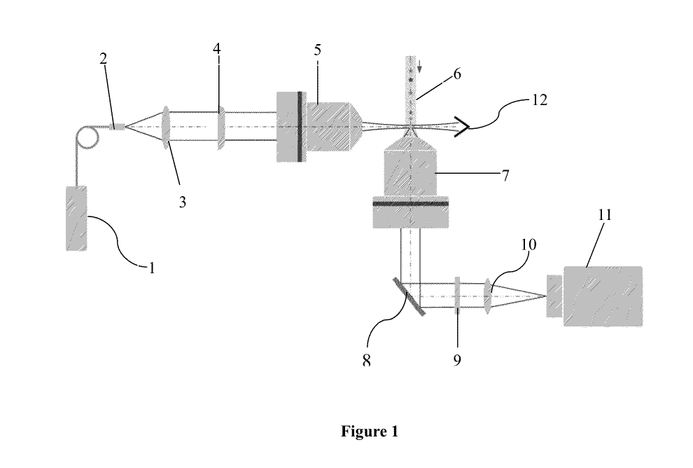

FIG. 1 illustrates the system design of the present invention. The presently claimed flow fluorescence microscopic imaging device includes the light sheet generation unit, liquid sample delivery unit and fluorescence microscopic imaging unit. In the present invention, the flow direction of the liquid sample is parallel to the optical axis of the fluorescence microscopic imaging unit and is perpendicular to the optical axis of the light sheet generation unit.

In FIG. 1, the single mode fiber (SMF) coupled laser output 1 delivers the light into capillary to form the light sheet by the collimating lens 3, the cylindrical lens 4, and the objective lens 5. The fluorescence light originated from the illuminated particles crossing the light sheet is collected onto the back focal plane of the fluorescence microscopic imaging unit with the help of the objective 7, the mirror 8, the filter 9 and the tube lens 10. In essence, the fluorescence light is brought to focus at sensor chip of the camera 11. For all intents and purposes, the fluorescence images of the particles are captured, displayed, stored and analysed by a computer. The images obtained do not suffer DOF problems even when their dimensions are much larger than the light sheet's thickness thus realizing highly focused images.

The Light Sheet Generation Unit

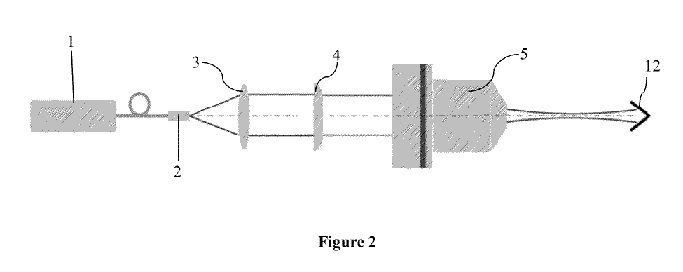

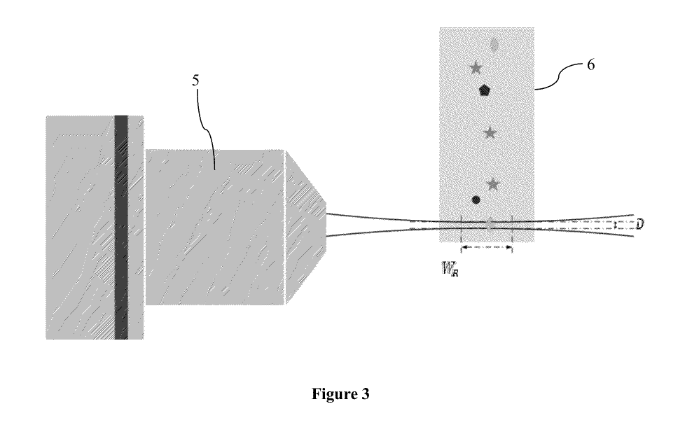

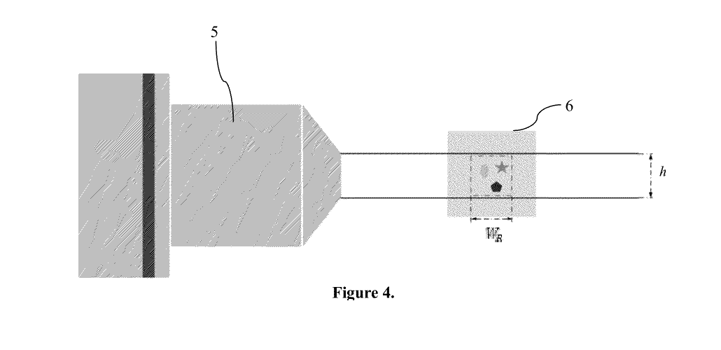

To overcome the limitation of the small DOF of the fluorescence imaging microscope, this invention adopts the light sheet formed by the light sheet generation unit to excite the fluorescence. This unit includes the SMF laser output, the collimating lens, the cylindrical lens and the microscopic objective. As shown in FIG. 2, the light from the SMF laser output 1 is brought to focus on the back focal plane of the microscopic objective 5 after passing the collimator lens 3 and cylindrical lens 4. This laser beam from the light sheet generation unit forms the light sheet of which the thickness is close to that obtained by the diffraction limit after going through the objective 5 with the beam waist located close to the focal point of the objective 5. The light sheet impinges onto the capillary 6 normally with the position of the beam waist located at the center of the capillary 6. The position of the beam waist is also that of the center of field of view of the fluorescence microscope. FIG. 3 and FIG. 4 show the side view and the top view of the light sheet respectively.

The width of the light sheet h in FIG. 4 is determined by the diameter of the collimated laser beam, the focal length of the cylindrical lens 4 and the focal length of the microscopic objective 5. The thickness of the light sheet, D, given by D≈λ/NA, where λ is the wavelength of the light and NA is the numerical aperture of the objective. The length of the corresponding Rayleigh area is W_{R}=±πD²/4λ. If D and the wavelengths are assumed to be 6 μm and 450 nm, respectively, then W_{R} would be about 126 μm. When the thickness of the light sheet source is less than or close to the depth of field of the fluorescence microscopic imaging unit, in the range of the Rayleigh area of the light sheet, the thickness of the light sheet is approximately uniform. The obtained fluorescence images of the cell particles are well-focused because all the illuminated parts of the sample are located within the DOF of the microscopic imaging unit. The light sheet in the present invention can also be achieved by a single cylindrical lens. Generally, the light sheet of which the thickness is close to the dimensions set by the diffraction limit is difficult to obtain by using single cylindrical lens because the aberration of the cylindrical lens is hard to be controlled to obtain theoretical limits.

The laser wavelength of the laser device can be 450 nm, 473 nm, 488 nm, 532 nm and so on. While there are more choices of color to optimize for maximal excitation of the fluorophores within the particles.

Liquid Sample Delivery Unit

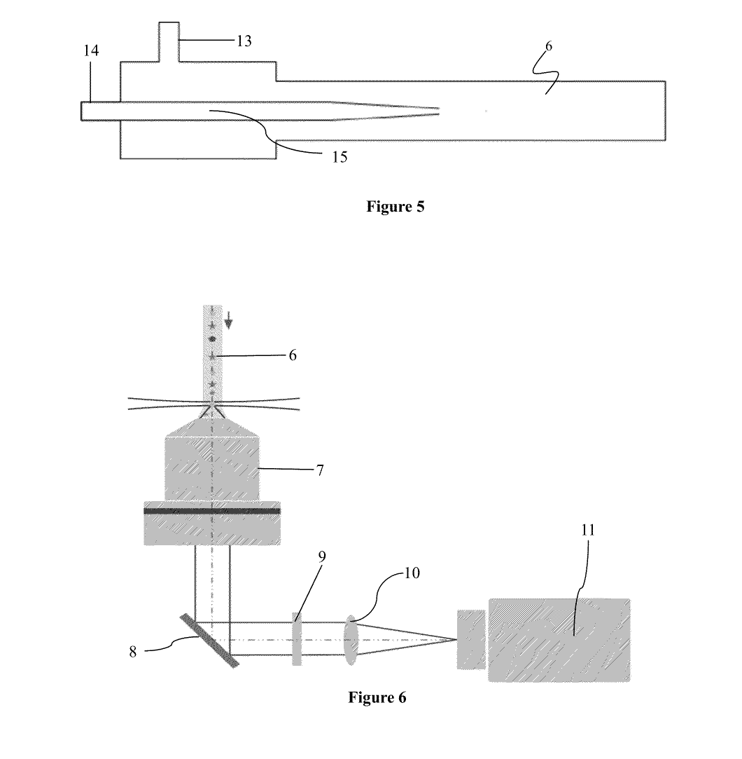

The liquid sample delivery unit includes injection pumps, hoses, a flow chamber, and the liquid sample. The sample flow chamber is as shown in FIG. 5. The sheath flow is introduced into the inlet 13 by the injection pump (not shown in the figure) where the liquid sample is pushed into the capillary 15 through the sample inlet 14 by another injection pump (not shown in the figure); and the sample being pushed into the capillary follows the sheath flow to flow at the core of the capillary 6. This enables all particles have the same speeds within the field of view of the imaging system. The flow direction of the sample runs parallel to that of the fluorescence microscopic imaging. The size and the flow rate of the central sample flow tube are adjusted by controlling the pressure on sample delivery unit, thereby, controlling the rate of sheath flow of the sample. The size of the central sample flow tube is less than or equals to the length of the Rayleigh area, to ensure that all samples can flow past the Rayleigh area of the light sheet. The flow rate of sample delivery can be adjusted with high precision and be stable over time to minimize errors. The sample is brought to flow normally to the lens surface hitting it directly with the flow. Waste liquid is discharge at the sides of the objective and discharged into waste reservoir. The transparent sample flow chamber is fixed onto a three-dimensional translation stage, and the movement precision of this stage is fine in the micron magnitude.

Fluorescence Microscopic Imaging Unit

The composition of the fluorescence microscopic imaging unit is similar to that of a standard fluorescence microscope. The structural design is shown in FIG. 6. The imaging object 7 is an infinity-corrected water dipping objective lens. The range between objective and lighting area is filled with the water outflowing from the sample introduction unit. The samples produce fluorescence images on the light sensors of the camera 11 after being excited in the sample delivery capillary 6 by the light sheet through the objective 7, mirror 8, filter 9 and tube lens 10. The choice of the filter 9 is determined by the fluorescence wavelength detected.

The field of view of the fluorescence microscopic imaging unit is determined by the length of the Rayleigh area of the light sheet and the size of the central sample flow. During an image capture a section of the particle is gathered at a time such that the exposure time ensures adjacent sections to be sampled at subsequent times. The fluorescence images for each section recorded can be used to obtain a 3D projection of the cell particles. An image stack is captured for each particle to be used to the reconstruction of the 3D information. The exposure time of the camera is controlled by the computer and it can be adjusted according to the concentration and the flow rate of the sample. This control ensures that each particle captures a set of images adequately for detailed 3D reconstructions.

In a second embodiment of the invention, the following provides the experimental setup:

Experimental Setup

FIG. 1 shows the schematic diagram of our light sheet 3D imaging flow cytometer. A flow sheath is used to hydro-dynamically focus the particles into the central part of a square capillary to achieve uniform laminar flow. The particles flow orthogonally through the light sheet plane and exit sideways onto the water dipping imaging objective lens. A suction tube (not shown) is then used to collect the waste liquid. An inverted fluorescence microscope is positioned to take the perfectly focused image of the illuminated section. As different layers, or sections, are illuminated when the particles traverse through the beam, a stack of fluorescent images of the phytoplankton cells are obtained. Basically, the 3D imaging flow cytometer comprises three parts as follows:

I. Light Sheet Generation Unit

For flexibility and ease of alignment, a single mode fiber (SMF) is used to couple a 25 mW 450 nm laser for generating the light sheet. The wavelength of the laser is chosen to maximize the excitation efficiency of the chlorophyll-a in the phytoplankton. The laser is first collimated with a singlet lens (BPX050, Thorlabs) and then produces the light sheet with a cylindrical lens (Cylinder achromat 101.6 mm FL, Melles Griot) in combination with an objective (Epiplan 10×/0.2 HD, Carl Zeiss).

The thickness of the beam waist and the Rayleigh range of the light sheet is mainly determined by the effective NA of the illumination objective used. Varying the distance between the cylindrical lens and the illumination objective, the width of the light sheet generated can be changed. The size of the light sheet is optimized to fit the sample core and field of view of the image detection unit.

II. Image Detection Unit

This unit is essentially an inverted fluorescence microscope. The water dipping objective (W N-Achroplan 40×/0.75, Carl Zeiss) and the tube lens (BPX085, Thorlabs) make up an infinity corrected microscope yielding a total magnification of 48×. As the chlorophyll-a fluorescence has a peak emission around 685 nm, a bandpass filter centered at 684 nm (FF02-684/24, Semrock) is used for laser rejection and for detection of the fluorescence emission. The final image is record with a fast camera (PCO, 1200 hs with 1280×1024 pixels, pixel size 12×12 μm²). It has a readout speed of 636 frames per second (fps) at full frame resolution.

III. Sample Delivery Unit

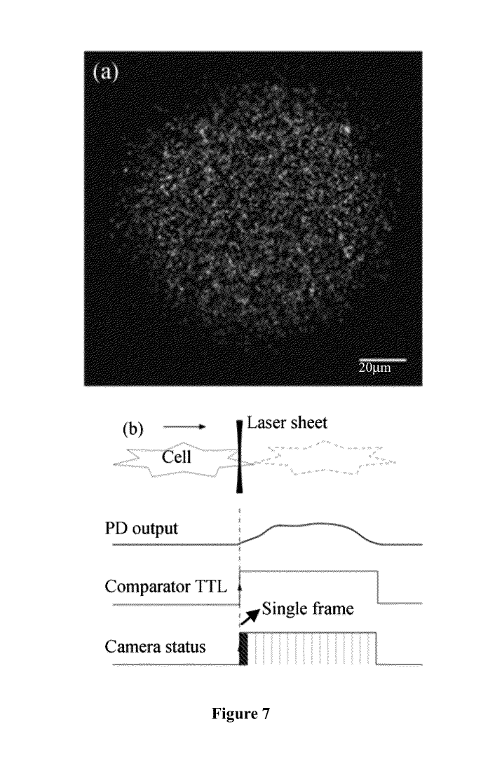

The flow cell is similar to that of a conventional flow cytometer. Samples are injected from the center channel and are hydro-dynamically focused through a square flow capillary. The square capillary has an inner size of 1 mm and it can provide a flat optical surface for laser transmission. The position of the sample core is finely controlled by XYZ translation stages to align with the beam waist of the light sheet. The sample volume flow rate is optimized to be 0.5 μl/min, which corresponds to a flow speed close to 1 mm/s. It is a compromise among axial resolution, throughput and sensitivity of the imaging system. FIG. 7(a) is a laser scattering image of the sample core captured with 500 nm fluorescent beads to test the particle confinement ability of the flow tube. It clearly showed the desired diameter of ˜100 μm.

A photodiode (PD) is used to detect the chlorophyll-a fluorescence signal as triggers for the camera. FIG. 7(b) shows the trigger timing and camera control waveforms. This triggering scheme permits phytoplankton cell identification from untreated samples containing detritus and other inorganic particles. And the axial thickness that single frame covered is determined by the particle velocity and exposure time of the single frame.

Experimental Results

Light Sheet Characterization

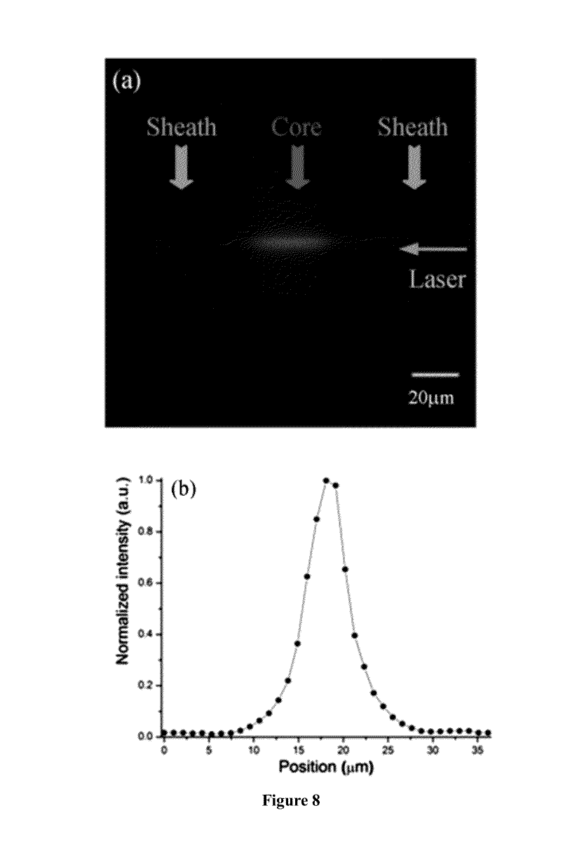

To ascertain the thickness of the light sheet, chlorophyll chemical solution flowing in the inner sheath with a diameter about 35 μm is used as an indicator. FIG. 8(a) shows the chlorophyll fluorescence illuminated by the laser sheet. The laser passes through the sample core horizontally and the sample flows vertically. The sample core is imaged with a 5×/0.2 objective lens from the side and recorded with a video camera. FIG. 7(b) gives the intensity profile of the light sheet. The intensity profile has FWHM (Full Width at the Half Maximum) of 5.39±0.13 μm.

The optimized field of view of the image detection unit should be within the Rayleigh range of the light sheet. With a thickness of 5.39 μm at the beam waist, the Rayleigh range of the light sheet is slightly larger than 50 μm. The core diameter is adjusted to 100 μm that guarantees all the cells cross through the light sheet at the uniformly illuminated central area.

Optical Resolution Determination

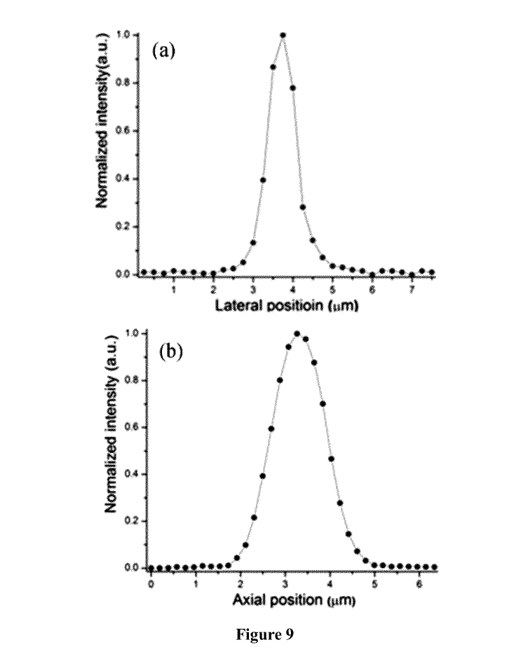

The point spread function (PSF) of the optical system is measured by using 500 nm fluorescent beads. For lateral PSF measurement, fluorescence images of individual beads are acquired. The volume flow rate is 0.5 μl/min; the sample flow has a core diameter of 100 μm and a speed of 1 mm/s. A region of interest (ROI) of 580×580 pixels on the camera chip is selected so that it can efficiently cover the sample core as FIG. 7(a) shows. Each bead takes only a few milliseconds to cross the laser sheet plane. The exposure time for each frame is set to 100 ms so that it can collect many beads' fluorescence as they pass through the laser sheet plane. FIG. 9(a) illustrates the lateral PSF of the optical imaging system. The Airy disk measured has a FWHM of 0.81±0.07 μm that covers ˜9 pixels on the camera. This result shows the beads pass through the light sheet perpendicularly without significant deviation.

Axial scattering PSF is measured to evaluate the axial resolution of the optical system. The flow conditions for axial PSF determination are the same to that of the lateral PSF measurement. The exposure time for a frame is set to 200 μs such that a stack of images of individual beads could be captured as they flow through the laser sheet plane. A ROI of 130×130 pixels is used to further increase the frame rate. An averaged intensity profile of 15 beads is generated for the axial PSF as shown in FIG. 9(b). The FWHM of the axial scattering PSF is 1.42±0.15 μm. This measured result agrees well with the data published by other researchers. The axial PSF is determined by the thickness of the light sheet plane and the axial PSF of the image detection optics. The theoretical depth of focus of the image detection optics is about 1.5 μm. It should be noted that the slight improvement in axial resolution is originated from enhancing image contrast with light sheet illumination. The results on the illumination tracks of the beads showed small lateral position shift. This shift could be caused by the Brownian motion of the particle in the solution. However, the shift observed is always within one pixel and for large particles this effect will be minimal.

Phytoplankton Samples Testing

The instrument constructed could cover a range of sizes from microns to tens of microns, which comprise many dinoflagellates, diatoms and potentially harmful algal blooms species that are commonly found in coastal waters. Two lab cultured toxic dinoflagellate species, Gambierdiscus sp. and Procentrum sp. are used to test the application feasibility of the 3D imaging flow cytometer in phytoplankton measurements. To get high contrast fluorescence images, the frame exposure time is optimized at 750 μs. With a flow speed of 1 mm/s, each frame scans an axial thickness of 0.75 μm. Under these conditions, the axial resolution for the system is about 2 μm. The number of the images obtained for a single particle is determined by a number of factors including the flow speed, particle size, orientation of the cell, and the preset trigger level.

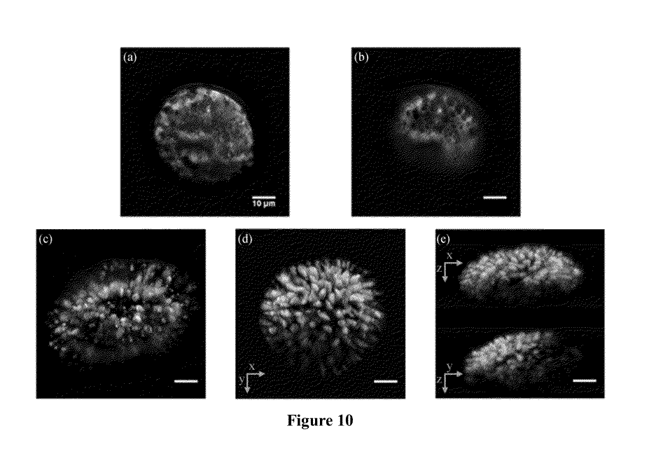

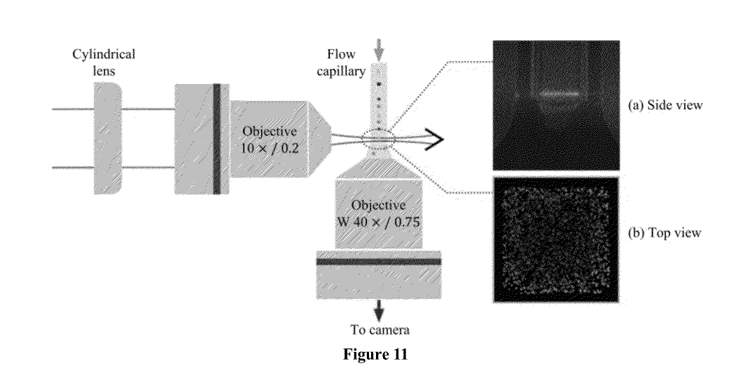

FIG. 10 are 3D projection images generated from the image stacks taken for Gambierdiscus sp. and Procentrum sp. FIG. 10(a) is a 3D projection of a stack of 30 images of Procentrum sp. The total sampling time to acquire the stack is 22.5 ms. FIG. 10(b) is a frame out of the stack that reveals a hollow structure of chlorophyll-a in Procentrum sp. The hollow structure is hard to notice in FIG. 10(a), where the whole corpus is projected onto a 2D plane. In conventional microscopy, the scenario is even worse as the photons from out-of-focus planes would also contribute to the blur of the images. FIGS. 10(c) and 10(d) are two different Gambierdiscus sp. cells. The chlorophyll-a structures are slightly different between the two particles with protruding rod-like structures. The small variation between the two cells can be interpreted to be at different stages of cell development, which is common for cultured samples. It can be clearly seen from the images that the chlorophyll-a structure in phytoplankton cells is very distinct for different species and this information could be very likely to use for taxonomy applications of selected micophytoplankton species. FIG. 10(e) illustrates the projections along the lateral directions of the same stack used in FIG. 10(d). The shadowing artifacts, one of the side effects of single beam light sheet illumination, could be easily observed in FIG. 10(e). This could be overcome by illuminating the sample from opposite sides.

Conclusion for the Second Embodiment of the Present Invention

A new light sheet based 3D fluorescence imaging flow cytometer that could scan a large number of phytoplankton cells with high spatial resolution in a short time is provided in the present invention. The FWHM of lateral fluorescence PSF achieved is 0.81±0.07 μm and the FWHM of axial scattering PSF is 1.42±0.15 μm. The throughput of the instrument is quantified by the sample volume flow rate of 0.5 μl/min, which benefits from the improvement that particles' chemical morphology can be acquired without the need of sample immobilization. The intra-cellular 3D chlorophyll-a structure images obtained from lab cultured Gambierdiscus sp. and Procentrum sp. samples by the method suggest its high potential for phytoplankton identifications.

In a third embodiment of the present invention there is presented the following experiment:

Materials and Methods

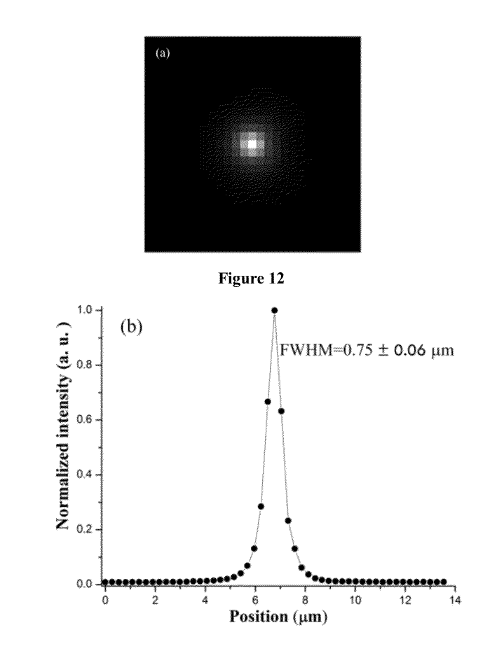

The schematic diagram of the 2D fluorescence imaging flow cytometer is shown in FIG. 11. A 450 nm laser is used to excite the chlorophylls in the phytoplankton that emit fluorescence light at wavelengths around 685 nm. The light sheet is formed with a cylindrical lens (Cylinder achromat 101.6 mm FL, Melles Griot) in conjunction with an illumination objective (Epiplan 10×/0.2 HD, Carl Zeiss) [16]. The fluorescence images are captured with an inverted fluorescence microscope, which comprises a water dipping lens (W N-Achroplan 40×/0.75, Carl Zeiss), a filter (FF02-684/24, Semrock), a tube lens and an electron-multiplying charge-coupled device (EMCCD) camera (PhotonMax: 1024B, Princeton Instruments). Samples are introduced into a 200×200 μm2 square capillary with a syringe pump and flow directly onto the imaging water dipping objective. The light sheet is focused across the flow capillary near the outlet as shown in FIG. 11(a). The direction of the flow is perpendicular to the light sheet plane and is parallel with the optical axis of the fluorescence microscope. FIG. 11(b) shows the beam illumination in the flow capillary taken with florescent particles (chlorella). Because of the shear stress, the flow is faster at the center than near the walls of the flow capillary; hence the cells look dimmer at the center of the capillary. Meanwhile, the shear forces drive the cells away from the walls, which reduce the optical vignetting caused by the capillary walls.

Using chlorophyll solution, the bright track of the laser sheet passing through the flow capillary can be observed as shown in FIG. 11(a). The lateral image is taken with a 5×/0.2 objective from a video camera. The thickness of the light sheet measured is 5.39 μm at the beam waist and about 10 m near the walls of the flow capillary. As the theoretically calculated depth of field of the fluorescence microscope is about 2 μm, it could be expected that using light sheet illumination can efficiently suppress the fluorescence background. However, there still remains an amount of out-of-focus light, which can be further removed with post image processing using an iterative deconvolution algorithm. The general equation for the intensity integrated 2D images G(xᵢ,yᵢ) recorded as the 3D object passing through the focus is given by:

G(xᵢ,yᵢ)=H(xᵢ,yᵢ,xₒ,yₒ) [symbol] S(xₒ,yₒ).

where H(xᵢ,yᵢ,xₒ,yₒ) is the integrated-intensity projection of the 3D point spread function (PSF) of the imaging system; [symbol] denotes convolution operation and S(xₒ,yₒ) is a perfect 2D projection of the object. Thus, the intensity integrated images obtained can be deconvolved to improve image fidelity with a prior known H(xᵢ,yᵢ,xₒ,yₒ).

Using fluorescent beads with a size of ˜500 nm, the PSF of the imaging system is measured. The volume flow rate for PSF measurement is 10 μl/min. With a cross-section of 200×200 μm², the beads have an average speed of about 4.2 mm/s. It, therefore, takes about 2.5 ms for the beads to cross the light sheet plane. The exposure time is set to 100 ms per frame such that it integrates the fluorescence during the transit through the light sheet plane. A stack of 50 images is captured with approximately 100 beads per frame. Using randomly selected images, a collection of 200 beads are stacked to generate the airy disk as shown in FIG. 12(a). FIG. 12(b) gives the intensity profile of the airy disk which has a full width at the half maximum (FWHM) of 0.75±0.06 μm. The FWHM of the PSF occupies less than 9 pixels, which indicates the lateral motions of the beads crossing the light sheet plane, if any, is within the diffraction limit of the imaging optics.

With the measured PSF, the residual out-of-focus light is further suppressed by image post-processing. After background subtraction, each image was subjected to the Tikhonov-Miller iterative restoration algorithm for reassigning the out-of-focus light to an in focus location. Deconvolution was carried out using the software DeconvolutionLab, ImageJ plug-in, a regularization parameter of 0.0001 and an iteration number of 15. The deconvolution process for a frame (700×700 pixels) takes less than one second. All the algorithms were run on a PC with an Intel Core i7 3.6 GHz CPU and 16 GB of RAM.

Experimental Results

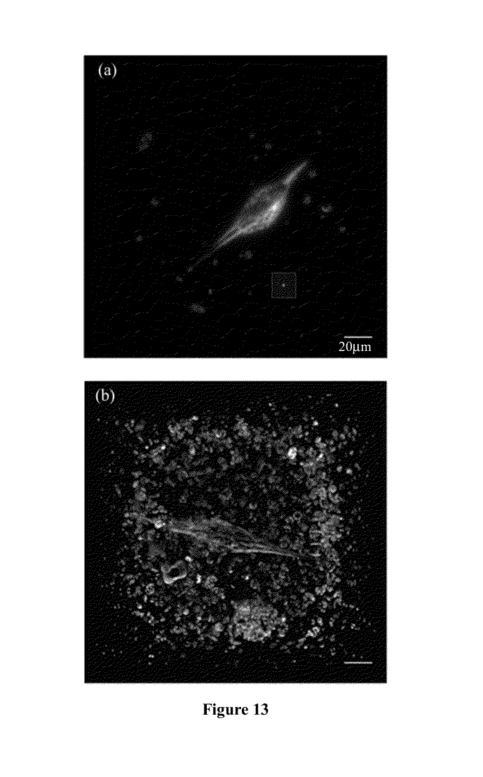

FIG. 13(a) gives an image captured from a fresh untreated coastal water sample with an exposure time of 1 second. The sample flows at a volume rate of 1 ml/min, which corresponds to an average speed of 0.42 m/s. Under this flow speed, no motion-blur artifacts were detected in the image because of the special flow configuration used. The large particle in the center is likely to be a dinoflagellate, Ceratiumfurca, which is a frequent visitor in the Hong Kong coasts. It could be seen that the internal structures are clearly visible and detailed enough for possible visual particle identification. The brightness in the small gray square area is adjusted to show the occurrence of small picophytoplankton whose size is under the diffraction limit.

As the fluorescence imaging flow cytometer developed is free from motion-blur, the maximum volume rate is mainly limited by the sensitivity of the camera. In this work, the volume rate is set to 1 ml/min so that the system is able to sense small picophytoplankton. However, if large phytoplankton particles were targeted, the volume rate could be further increased. The number of particles captured in a frame is determined by the flow speed, exposure time and phytoplankton cell abundance. For the particular untreated water samples, the exposure time is set to 1 second at flow speed of 1 ml/min such that the camera captures on average some tens of particles in a frame with low occurrences of overlapping.

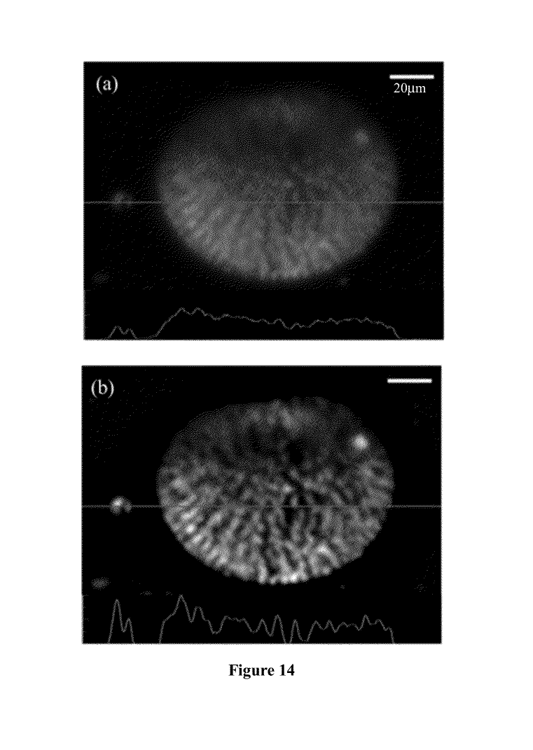

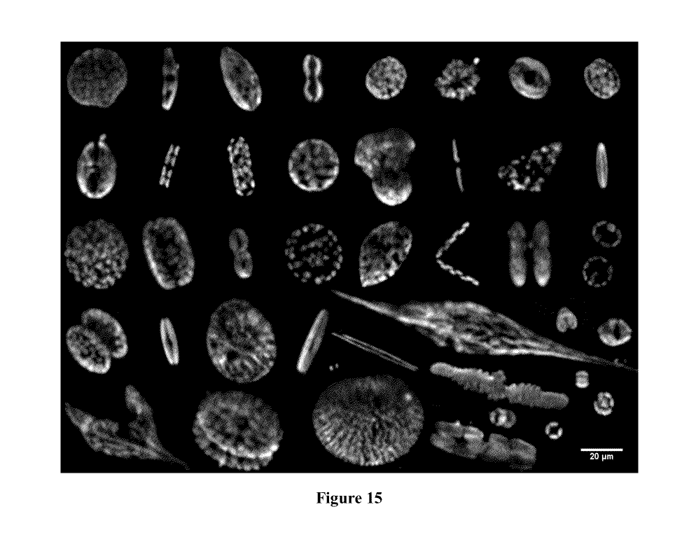

FIG. 14 gives a qualitative comparison between the original image and the restored image of a randomly selected cell. It shows that deconvolution has a remarkable performance in improving contrast by suppressing the out-of-focus light. The white curves at the bottom of FIGS. 14(a) and 14(b) are the pixel intensity profiles along the gray horizontal lines in both images. The intensity value is normalized to the maximum value of the two lines.

The 2D florescence imaging flow cytometer developed can screen a large volume of coastal water samples in a short time and can cover broad range of sizes from small picophytoplankton to large diatoms and dinoflagellates. The cell abundance, therefore, could be determined with much higher confidence than those done by bright-field microscopy, which has difficulties in observing small picophytoplankton. FIG. 13(b) presents the combined projection of a stack of 60 deconvolved images representing total particles in 1 ml of the sample. As expected, small cells dominate the abundance with only a few large cells present. The cell abundance measured is ˜4700 cells/ml, which is considerably denser than the abundance determined by conventional microscope counting technique (Data from Hong Kong marine water quality report: 1500˜4500 cells/ml).

Furthermore, the morphological information of the images of larger cells obtained with our instrument has high potential for taxonomic identification. FIG. 15 gives a small collection of images of larger phytoplankton showing different shapes, sizes, and structures captured from natural coastal water samples. For small particles, the instrument cannot be used to determine species. However, for particles with sizes larger than, say, 5 microns, the detailed images captured may be used to identify some unique species such as those of large diatoms and dinoflagellates.

One possible obstacle of the instrument developed for phytoplankton species identification is that the 2D images obtained depend greatly on the orientation of the phytoplankton particles. To tackle this issue, a 3D image database of the phytoplankton may be needed such that different viewing projections can be correlated with the images. This could be one of our future research directions by using the previous 3D imaging flow cytometer to establish the database and to develop artificial intelligence software for rapid automatic species identification.

Conclusion from the Third Embodiment of the Present Invention

A fast fluorescence imaging flow cytometer for taking 2D chlorophyll fluorescence images of phytoplankton from untreated coastal water samples is provided in the present invention. The instrument reported is free from the shallow depth-of-field issue and motion-blur effect. This is achieved by using a unique flow configuration, thin light sheet illumination and image deconvolution. The instrument developed measures water samples at a volume rate up to 1 ml/min with a lateral resolution less than one micron and covers a broad range of sizes from ˜1 μm to ˜200 μm. Images taken from the coastal water samples showed detailed morphological information that is unique to different phytoplankton species which can be used as a characteristic signature for phytoplankton species identification.

### INDUSTRIAL APPLICABILITY

The objective of the presently claimed invention is to provide a flow fluorescence microscopic imaging apparatus. More particularly, it relates to a fluorescence microscopic imaging apparatus which combines the fluorescence microscopy excited by light sheet and flow cytometry. The invention has application in providing a new methodology of flow fluorescence microscopic imaging device, which is able to solve the problem of small depth of field and the motion blur when the flow objects are imaged.

What is claimed is:

1. A flow fluorescence microscopy imaging apparatus comprising a light sheet generation unit, a liquid sample delivery unit, and a fluorescence microscopic imaging unit, wherein said light sheet generation unit comprises a light source, said light source comprising a laser light source capable of forming a laser light sheet; flow direction of the liquid sample delivery unit and optical axis of the fluorescence imaging unit are configured to be parallel to each other and perpendicular to the optical axis of the light sheet generation unit.

2. The apparatus according to claim 1, wherein thickness of the laser light sheet formed by the laser light source is close to depth-of-field of the fluorescence microscopic imaging unit.

3. The apparatus according to claim 1, wherein said light sheet generation unit further comprises a laser light output of a single mode fiber laser, a collimator lens, a cylindrical lens, and a microscope objective lens, in order to form said light sheet.

4. The apparatus according to claim 1, wherein the liquid sample delivery unit comprises injection pumps, hoses, and a flow chamber, wherein the sample follows a sheath flow to flow at the core of the capillary; cross-section of the capillary is square or circular.

5. The apparatus according to claim 1, wherein the fluorescence microscopic imaging unit comprises a liquid flowing out of the liquid sample delivery unit, which fills up a space between objective lens of the fluorescence microscopic imaging unit and an illumination plane of the light sheet; said objective lens is an infinity-corrected water dipping objective lens.

6. A flow fluorescence microscopy imaging method based on a flow fluorescence microscopic imaging apparatus, said method comprising forming a light sheet illumination at sample stream in a sample delivery unit of said apparatus generated by a laser light source; liquid samples flowing through the light sheet illumination stimulating fluorescence emission from fluorescent particles contained in the liquid samples and thereby forming images at the back focal plane of a fluorescence microscopic imaging unit of said apparatus; flow direction of the liquid samples and optical axis of the fluorescence imaging unit are parallel to each other and are perpendicular to optical axis of a light sheet generation unit of said apparatus.

7. The method according to claim 6, wherein thickness of the light sheet formed by the laser light source is close to depth-of-field of the fluorescence microscopic imaging unit.

8. The method according to claim 6, wherein said light sheet is formed by the light sheet generation unit comprising a laser light output of a single mode fiber laser, a collimator lens, a cylindrical lens, and a microscope objective lens.

9. The method according to claim 6, wherein the apparatus comprises a liquid sample delivery unit, said delivery unit comprising injection pumps, hoses, a flow chamber, and the liquid samples, the liquid samples follows a sheath flow to flow at the core of the capillary, wherein cross-section of the capillary is square or circular.

10. The method according to claim 6, wherein the fluorescence microscopic imaging unit comprises a liquid flowing out of the sample delivery unit, which fills up a space between objective lens of the fluorescence microscopic imaging unit and an illumination plane of the light sheet; said objective lens is an infinity-corrected water dipping objective lens.
